(19) United States
(12) Patent Application Publication
(10) Pub. No.: US 2011/0297015 A1
(43) Pub. Date: Dec. 8, 2011

(54) Apparatus for Automated Dehydration

(76) Inventor: Willie Clyde Hunter, Ooltewah, TN (US)

(21) Appl. No.: 13/071,073

(22) Filed: Mar. 24, 2011

Related U.S. Application Data
(60) Provisional application No. 61/397,033, filed on Jun. 7, 2010.

(51) Int. Cl. B30B 9/20; B30B 3/04; B30B 9/02

(52) U.S. Cl. 100/131; 100/176; 100/104

(57) ABSTRACT

An apparatus for automated dehydration is disclosed. In one embodiment, an automated dehydration apparatus includes a first roller press and a second roller press aligned substantially parallel to each other with distance between them as to cause fluid to be removed from materials as the materials pass between said first roller press and said second roller press where a motor drives the first roller press after receiving power from a power supply.

### PRIORITY CLAIM

This application claims priority over the Provisional Patent Application with Ser. No. 61/397,033 dated Jun. 7, 2010 which is incorporated herein by its entirety.

### FIELD OF INVENTION

The present invention relates to an apparatus for automated dehydration, more particularly to an apparatus for automatically removing fluid from materials via compression.

### BACKGROUND ART

There are various types of devices for removing fluid from cloth and similar materials. Unfortunately, none of these devices are automated and available to the general consumers other than a dryer for laundry. Often when an individual, whether in the kitchen, shower, restroom, or other location, needs to remove majority of fluid from a wash cloth or dish towel, the most common manner is to simply hand wring out the cloth manually by twisting the cloth in opposite directions. However, wringing the cloth requires both hands and an extraordinary amount of strength to remove the majority of the fluid form the cloth.

Use of both hands to wring a cloth is often not viable for injured or handicapped individuals and the strength required to manually wring the cloth may not be available to the young, handicapped, elderly, or particularly those suffering from arthritis or carpal tunnel syndrome. The wringing process is extremely inefficient and worse, is painful to the individuals with medical conditions that can limit the use of these extremities and prevent removal of the majority of the fluid absorbed in the cloth. Furthermore, repeated use of the hands to wring fluid from the cloth and the like material can cause pain in individuals that do not have medical conditions affecting the use of their hands.

Many devices have been created to assist individuals with limited use of their hands to allow normal activity in their day-to-day lives. These activities include simple daily tasks such as washing dishes and clothing, bathing, household cleaning and more; however, none of devices currently available address the issue of removing fluid from a cloth if one does not have full use of and an inordinate amount of strength in their hands.

Therefore, it is readily apparent that there is a need for an automated dehydration apparatus which minimizes and/or overcomes these deficiencies by providing the ability to remove fluids from cloths and similar materials even if the user has a medical condition which prevents full use of both hands. This would serve the functions of reducing cost, time, inefficiencies, pain, and medical procedures while increasing customer satisfaction by providing a portable automated apparatus for removing fluids from cloth and similar materials.

### SUMMARY OF THE INVENTION

Briefly described, in a preferred embodiment, the present invention overcomes the above-mentioned disadvantages and meets the recognized need for such a device by providing an efficient apparatus for automated dehydration which uses pressure exerted between a first roller press, preferably made of a hard rubber, and a second roller press, preferably made of a softer rubber, to remove fluid from a textile, cloth, fabric, or similar material. The first roller press and/or the second roller press are driven by a power gear motor, removing the necessity of hand wringing a hydrated material. This allows an individual with a handicap or insufficient strength in their hands to remove fluid from the hydrated material without risking further injury or causing pain.

According to its major aspects and broadly stated, the present invention in a preferred form is an apparatus for automated dehydration which includes a first roller press, and a second roller press. The second roller press is aligned substantially parallel to the first roller press with a distance from the first roller press causing fluid to be removed from a material as the material passes between the first roller press and the second roller press, a motor, wherein the motor drives the first roller press, and a power supply, wherein the power supply provides power to drive the motor. In another preferred embodiment the motor is preferably a power gear motor. Motorizing the first roller press, the second roller press, or a combination of both allows a user to remove fluid from a material without strenuous use of their hands, thereby reducing the risk of injury or discomfort.

In a further preferred embodiment, an apparatus for automated dehydration further includes an outer housing which forms a first aperture aligned with the first roller press and the second roller press to allow the passage of material through the first aperture and between the first roller press and the second roller press. The outer housing provides a stable structure for the apparatus for automated dehydration while protecting the motor and power input from fluid inadvertently reaching electrical components. In further another preferred embodiment, the outer housing forms a second aperture aligned beneath the first roller press and the second roller press to allow fluid removed from the material to drain. In addition to allowing an optimal position for the fluid to drain, the second aperture, preferably on the bottom of the outer housing, also allows for the dehydrated material to exit the outer housing after passing through the rollers. It is specifically contemplated that the apertures in the outer housing need not be positioned in the top and the bottom of the outer housing. The apertures could be positioned on the front and back of the outer housing as necessitated by location of the apparatus for automated dehydration.

In still another preferred embodiment, the first roller press includes a hard surface material, where a surface material of the second roller press is softer than the surface material of the first roller press. In a preferred embodiment, the surface material of the first roller press includes a hard rubber while the surface material of the second roller press includes a soft rubber. By differentiating the density of the first roller press and the second roller press, an appropriate amount of pressure is applied to the material being run between the first and second roller presses. The second roller press allows for compression to accommodate larger or thicker materials being passed through the automated dehydration apparatus.

In yet another preferred embodiment the supply of power includes a battery which may be rechargeable. In a further preferred embodiment, the power supply comprises an AC/DC power input adapter. Having a battery allows the automated dehydration apparatus to be transportable and used in locations without access to a power outlet while the addition of the AC/DC power input adapter allows for input of both alternating current and direct current.

In a preferred embodiment, the automated dehydration apparatus further includes a power switch, wherein the power switch controls power to the power supply. In a further preferred embodiment, the power switch is lighted. Additionally, it is meant to be recognized by one skilled in the art that other means for controlling the flow of electricity to the motor could be used. For exemplary purposes only, this could also include an infrared receiver, mechanical mechanism, or other switch that would allow for the automatic detection of a material inserted through the first aperture of the outer housing. Thus, the automated dehydration apparatus could be controlled by a conveniently backlit switch or by an automatic detection method, as understood by one skilled in the art.

In still another preferred embodiment, the automated dehydration apparatus further includes a secondary roller driver, wherein rotation of the first roller press causes rotation within the secondary roller driver, and wherein the secondary roller driver rotates the secondary roller press. The addition of the secondary roller drive allows both the first roller press and second roller press to both be rotated off of a single drive shaft. Additionally, in a preferred embodiment, the first roller press would be turned in a counter-clockwise direction and the second roller press would be turned in a clockwise direction if viewed from the location of the motor. This arrangement causes the first roller press and the second roller press to pull the material between them to remove the fluid.

In a further preferred embodiment, the automated dehydration apparatus further includes a forward and reverse switch, wherein the forward and reverse switch powers the motor such that material is pulled through and between the first roller press and the second roller press in a forward direction or a reverse direction. Having forward and reverse directions on the automated dehydration apparatus allows a user to control the direction of the material being passed through the roller presses. This added functionality enables the user to pass the materials through the roller presses in a convenient direction and further allows for any jam in the apparatus to be corrected. Additionally, more fluid can be removed from the material by operating the forward and reverse switch to allow the material to pass between the roller presses multiple times.

In another preferred embodiment, the automated dehydration apparatus further includes a drain tray, wherein the drain tray is positioned beneath the second aperture formed by the outer housing to collect the fluid removed from the material. In a further preferred embodiment, the drain tray is disposed on the outer housing. Additionally, in yet another preferred embodiment, the automated dehydration apparatus further includes a drain tube, wherein the drain tube is joined with an aperture formed within the drain tray or otherwise disposed thereon. The addition of a drain tray allows a convenient location for the fluid which is removed from the material by pressure after passing through the roller presses. The addition of a drain tube allows the removed fluid to be diverted to a preferred location such as a sink, bath, shower, container, or even outside. Thus, with the addition of the drain tray and the drain tube, the removed fluid can easily and safely be disposed.

In a further preferred embodiment, the automated dehydration apparatus further includes at least one stand disposed on the outer housing. The stand could be a single piece or multiple stands which lift the automated dehydration apparatus from a surface on which it is resting. This provides a convenient manner of placing the automated dehydration apparatus while allowing the material to easily pass between the roller presses. Further, it is specifically contemplated by the inventor and would be recognized by one skilled in the art that the stand could be removable and the automated dehydration apparatus could be wall mounted to allow installation of the apparatus in areas without sufficient counter space.

In yet another preferred embodiment, the automated dehydration apparatus further includes a first support bracket, wherein the first support bracket rotatably supports a first end of the first roller press, and wherein the first support bracket rotatably supports a first end of the second roller press, and a second support bracket, wherein the second support bracket rotatably supports a second end of the first roller press, and wherein the second support bracket rotatably supports a second end of the second roller press. In this manner the roller presses and the roller bearing assemblies are supported in a firm position while allowing the roller presses to easily be rotated by the motor. The presence of a first support bracket and a second support bracket allow the ends of the roller presses to be fixed and held in location while allowing the roller presses to freely rotate. This ensures that correct amount of pressure is applied to the hydrated material as it passes through the roller presses.

In still another preferred embodiment, the automated dehydration apparatus further includes a drive shaft connecting the motor and the first roller press. The drive shaft allows the motor to be placed further away from the roller presses, thus reducing the risk of fluid inadvertently accessing the motor and electrical components of the automated dehydration apparatus.

In another preferred embodiment the automated dehydration apparatus further includes a first roller bearing assembly disposed on a first end of the first roller press, a second roller bearing assembly disposed on a second end of the first roller press, a third roller bearing assembly disposed on a first end of the second roller press, and a fourth roller bearing assembly disposed on a second end of the second roller press. The presence of bearings disposed on the roller presses reduces friction within the automated dehydration apparatus, thereby reducing heat and the amount of power necessary to turn the roller presses. Additionally, the presence of roller bearing assemblies increases the longevity and lifetime of the automated dehydration apparatus.

In one preferred embodiment the automated dehydration apparatus further includes at least one case support disposed within the outer housing. Having at least one case support disposed within the outer housing increases strength of the outer housing while also dividing the roller presses and access to fluid from the electrical components.

More specifically, the present invention is an apparatus for automated dehydration which includes a first roller press, a second roller press, wherein the second roller press is aligned substantially parallel to the first roller press with distance from the first roller press causing fluid to be removed from material as the material passes through and between the first roller press and the second roller press, and wherein the first roller press has a hard surface, and wherein the second roller press has a surface with less density than the surface of the first roller press, a first roller bearing assembly disposed on a first end of the first roller press, a second roller bearing assembly disposed on a second end of the first roller press, a third roller bearing assembly disposed on a first end of the second roller press, a fourth roller bearing assembly disposed on a second end of the second roller press, a first support bracket, wherein the first support bracket rotatably supports the first roller bearing assembly, and wherein the first support bracket rotatably supports the third roller bearing assembly, and a second support bracket, wherein the second support bracket rotatably supports the second roller bearing assembly, and wherein the second support bracket rotatably supports the fourth roller bearing assembly, an outer housing, wherein the first support bracket and the second support bracket are disposed within the outer housing, wherein the outer housing forms a first aperture aligned with the first roller press and the second roller press to allow the passage of materials through the first aperture between the first roller press and the second roller press, and wherein the outer housing forms a second aperture aligned beneath the first roller press and the second roller press to allow fluid removed from the material to drain, a drive shaft coupled with the first roller press, and a motor, wherein the motor drives the drive shaft, a power supply, wherein the power supply drives the motor, a secondary roller driver, wherein rotation of the first roller press causes rotation within the secondary roller driver, and wherein the secondary roller driver rotates the secondary roller press, a forward and reverse switch, wherein the forward and reverse switch powers the motor such that material is pulled through and between the first roller press and the second roller press in forward direction or reverse direction, a drain tray, wherein the drain tray is positioned beneath the second aperture formed by the outer housing to collect fluid from the material, a drain tube wherein the drain tube is connected with an aperture formed within the drain tray, and at least one stand disposed on the outer housing.

Accordingly, a feature and advantage of the present invention is its ability to allow a user to remove fluid from a material such as cloth or the like without exerting undue pressure on the user's hands.

Another feature and advantage of the present invention is its ability to allow handicapped individuals to remove fluid from materials without the use of both hands.

Still another feature and advantage of the present invention is its ability to remove fluid from a material while allowing a user to focus their attention elsewhere.

Yet another feature and advantage of the present invention is the transportable nature of the automated dehydration apparatus provided by a compartmentalized battery.

Yet still another feature and advantage of the present invention is the ability to remove a vast majority of fluid from a material without causing the user pain or discomfort.

A further feature and advantage of the present invention is its ability to transport away the fluid removed from the material.

Still another feature and advantage of the present invention is its ability to operate in a forward and reverse mode to remove more fluid from material and remove any material that becomes jammed in the apparatus for automated dehydration.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to the elements throughout, and in which:

FIG. 1 shows a perspective view of a preferred embodiment;

FIG. 2 shows a perspective view in partial cutaway of a preferred embodiment, showing the interior components;

FIG. 3 shows a top elevated view of a preferred embodiment;

FIG. 4 shows an elevated right view in partial cross-section of a preferred embodiment; and

FIG. 5 shows an electrical wiring diagram of a preferred embodiment.

### DETAILED DESCRIPTION OF THE PREFERRED AND SELECTED ALTERNATE EMBODIMENTS

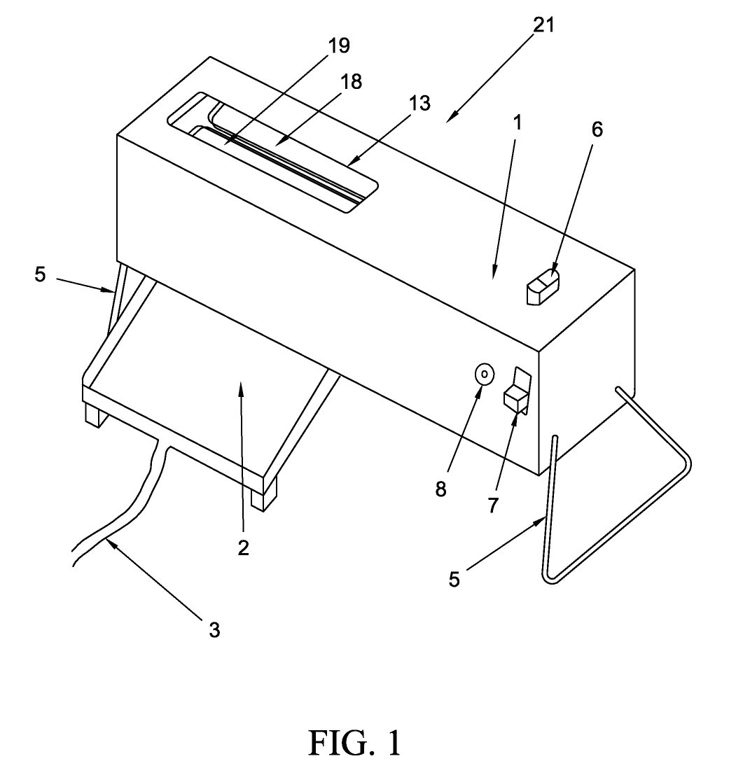

In describing the preferred and selected alternate embodiments of the present invention, as illustrated in FIGS. 1-5, specific terminology is employed for the sake of clarity. The invention, however, is not intended to be limited to the specific terminology so selected, and it is to be understood that each specific element includes all technical equivalents that operate in a similar manner to accomplish similar functions.

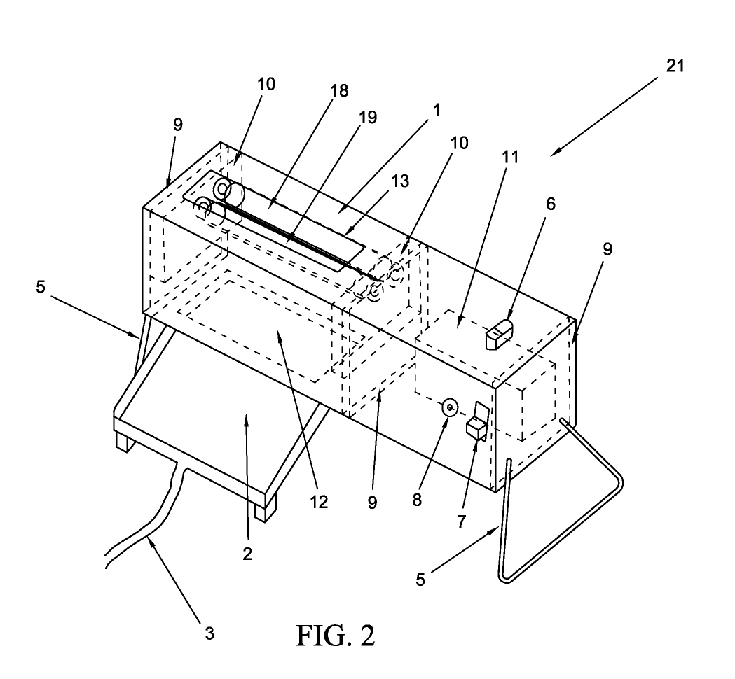

Referring now to FIGS. 1 and 2, the present invention in a preferred embodiment includes an apparatus for automated dehydration 21. The apparatus for automated dehydration 21 preferably further includes a roller press assembly 4. The roller press assembly 4 is further includes a first roller press 18 and a second roller press 19. The roller press assembly 4 is positioned beneath a first aperture 13 in an outer housing 1. The outer housing 1 has power switch 6 which is preferably backlit and a forward and reverse switch 7 disposed on the outer housing 1. Further, the outer housing 1 preferably has at least one outer case stand 5 removably disposed on outer housing 1 to support the apparatus for automated dehydration 21. The outer housing 1 also has an AC/DC power input 8 disposed thereon. A drain tray 2 is preferably disposed beneath a second aperture 12 in the outer housing 1 (as shown in FIG. 2) for collection of the fluid removed from material passed through the roller press assembly 4. The drain tray 2 additionally has drain tube 3 disposed thereon for the removal of fluid from the drain tray 2.

Referring now more specifically to FIG. 2, the first roller press 18 and the second roller press 19 are rotatably secured within the outer housing 1 by a first support bracket 10 and a second support bracket 10. The outer housing 1 is preferably further supported via at least one case support 9. The outer housing 1 also preferably contains a battery 11 for powering the automated dehydration apparatus 21 in locations without access to electricity.

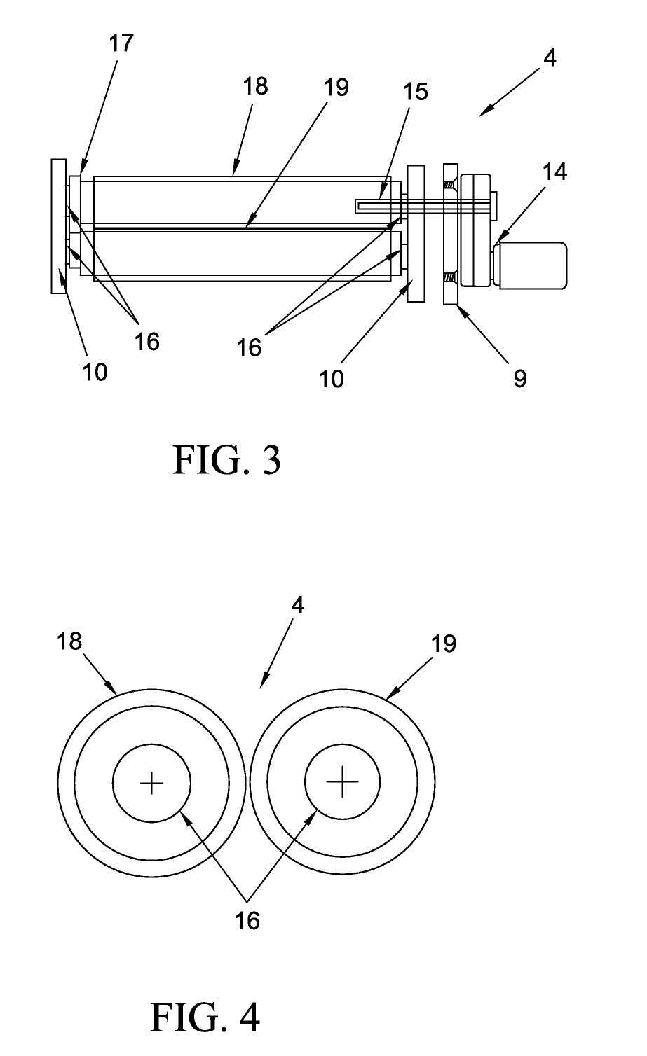

Referring now more specifically to FIG. 3, the roller press assembly 4 includes the first roller press 18 and the second roller press 19. The first roller press 18 and the second roller press 19 are rotatably secured by the first support bracket 10 and the second support bracket 10. The first roller press 18 is rotated via a drive shaft 15 which is driven by a motor 14. The first roller press 18 rotates a secondary roller drive 17, which in turn rotates the second roller press 19 in a direction opposite to that of the first roller press 18. Additionally, the first roller press 18 and the second roller press 19 preferably have roller ringer bearings 16 disposed on each end to reduce friction while the automated dehydration apparatus 21 is operated. The drive shaft 15 preferably runs through an aperture in at least one case support 9, thereby reducing the risk of fluid accessing the motor 14.

Referring now more specifically to FIG. 4, the roller press assembly 4 further includes the first roller press 18, wherein the first roller press 18 is preferably made with a hard rubber, and the second roller press 19, wherein the second roller press 19 is preferably made with a rubber softer in relation to the rubber used on the first roller press 18. Additionally, FIG. 4 illustrates the roller ringer bearings 16 disposed at the end of the first roller press 18 and the second roller press 19.

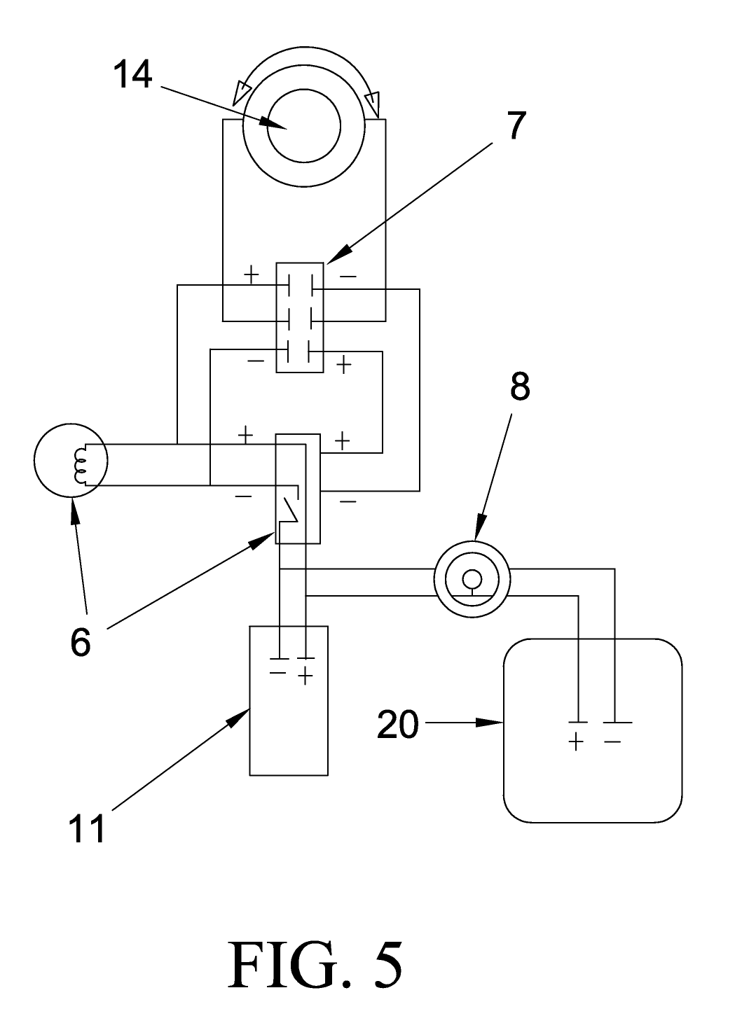

Referring now more specifically to FIG. 5, an electrical wiring diagram for the apparatus for automated dehydration 21 is shown, wherein electricity is taken in via an AC/DC power input adapter 20 and travels through an AC/DC power input 8. The electricity preferably charges and/or recharges battery 11. A power switch 6 is illustrated as being backlit and controls power to the motor. Forward and reverse switch 7 controls direction of the motor 14.

The foregoing description and drawings comprise illustrative embodiments of the present invention. Having thus described exemplary embodiments of the present invention, it should be noted by those skilled in the art that the embodiments within disclosures are exemplary only, and that various other alternatives, adaptations, and modifications may be made within the scope of the present invention. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. An automated dehydration apparatus comprising:
a first roller press;
a second roller press, wherein the second roller press is aligned substantially parallel to the first roller press with a distance from the first roller press causing fluid to be removed from material when the material is passed between the first roller press and the second roller press;
a motor to drive the first roller press; and
a power supply to provide power to drive the motor.

2. The apparatus of claim 1, further comprising:
an outer housing, wherein the outer housing forms a first aperture aligned with the first roller press and the second roller press to allow the passage of the material through the first aperture and between the first roller press and the second roller press.

3. The apparatus of claim 1, wherein the motor is a power gear motor.

4. The apparatus of claim 1, wherein the first roller press comprises a hard surface material, and wherein a surface material of the second roller press is softer than the surface material of the first roller press.

5. The apparatus of claim 4, wherein the surface material of the first roller press comprises a hard rubber, and wherein the surface material of the second roller press comprises a rubber having less density than the surface material of the first roller press.

6. The apparatus of claim 1, wherein the power supply comprises a battery.

7. The apparatus of claim 1, wherein the power supply comprises an AC/DC power input adapter.

8. The apparatus of claim 2, wherein the outer housing forms a second aperture aligned beneath the first roller press and the second roller press to allow fluid removed from the material to drain.

9. The apparatus of claim 1, further comprising a power switch, wherein the power switch controls power to the power supply.

10. The apparatus of claim 1, further comprising a secondary roller driver, wherein rotation of said first roller press causes rotation within said secondary roller driver, and wherein said secondary roller driver rotates said secondary roller press.

11. The apparatus of claim 1, further comprising:
a forward and reverse switch, wherein the forward and reverse switch powers the motor such that the material is pulled through and between the first roller press and the second roller press in a forward direction or a reverse direction.

12. The apparatus of claim 8, further comprising:
a drain tray, wherein the drain tray is positioned beneath the second aperture to collect fluid removed from the material.

13. The apparatus of claim 12, further comprising:
a drain tube wherein the drain tube is coupled with an aperture formed within the drain tray.

14. The apparatus of claim 2, further comprising at least one stand disposed on the outer housing.

15. The apparatus of claim 1, further comprising:
a first support bracket, wherein the first support bracket rotatably supports a first end of the first roller press, and wherein the first support bracket rotatably supports a first end of the second roller press; and
a second support bracket, wherein the second support bracket rotatably supports a second end of the first roller press, and wherein the second support bracket rotatably supports a second end of the second roller press.

16. The apparatus of claim 1, further comprising a drive shaft connecting the motor and the first roller press.

17. The apparatus of claim 1, further comprising:
a first roller bearing assembly disposed on a first end of the first roller press;
a second roller bearing assembly disposed on a second end of the first roller press;
a third roller bearing assembly disposed on a first end of the second roller press; and
a fourth roller bearing assembly disposed on a second end of the second roller press.

18. The apparatus of claim 17, further comprising:
a first support bracket, wherein the first support bracket rotatably supports the first roller bearing assembly, and wherein the first support bracket rotatably supports the third roller bearing assembly; and
a second support bracket, wherein the second support bracket rotatably supports the second roller bearing assembly, and wherein the second support bracket rotatably supports the fourth roller bearing assembly.

19. The apparatus of claim 2, further comprising at least one case support disposed within the outer housing.

20. An automated dehydration apparatus comprising:
a first roller press;
a second roller press, wherein the second roller press is aligned substantially parallel to the first roller press with a distance from the first roller press causing fluid to be removed from material as the material passes through and between the first roller press and the second roller press, and wherein the first roller press has a hard surface, and wherein the second roller press has a surface with less density than the surface of the first roller press;
a first roller bearing assembly disposed on a first end of the first roller press;
a second roller bearing assembly disposed on a second end of the first roller press;
a third roller bearing assembly disposed on a first end of the second roller press;
a fourth roller bearing assembly disposed on a second end of the second roller press;
a first support bracket, wherein the first support bracket rotatably supports the first roller bearing assembly, and wherein the first support bracket rotatably supports the third roller bearing assembly;
a second support bracket, wherein the second support bracket rotatably supports the second roller bearing assembly, and wherein the second support bracket rotatably supports the fourth roller bearing assembly;
an outer housing, wherein the first support bracket and the second support bracket are disposed within the outer housing, and wherein the outer housing forms a first aperture aligned with the first roller press and the second roller press to allow the passage of the material through the first aperture and between the first roller press and the second roller press, and wherein the outer housing forms a second aperture aligned beneath the first roller press and the second roller press to allow fluid removed from the material to drain;
a drive shaft coupled to the first roller press;
a motor, wherein the motor drives the drive shaft;
a power supply, wherein the power supply drives the motor;
a forward and reverse switch, wherein the forward and reverse switch powers the motor such that the material is pulled through and between the first roller press and the second roller press in a forward direction or a reverse direction;
a drain tray, wherein the drain tray is positioned beneath the second aperture formed by the outer housing to collect fluid removed from the material;
a drain tube, wherein the drain tube is coupled with an aperture formed within the drain tray; and
at least one stand disposed on the outer housing.
